(19) United States
(12) Patent Application Publication
(10) Pub. No.: US 2006/0158503 A1
(43) Pub. Date: Jul. 20, 2006

(54) Tape printing apparatus

(75) Inventors: Hideo Sodeyama, Matsumoto-shi (JP); Kenichi Tanabe, Soka-shi (JP)

Correspondence Address: HOGAN & HARTSON L.L.P., 500 S. GRAND AVENUE, SUITE 1900, LOS ANGELES, CA, 90071-2611, US

(73) Assignees: SEIKO EPSON CORPORATION; KING JIM CO., LTD.

(21) Appl. No.: 11/330,468

(22) Filed: Jan. 12, 2006

(30) Foreign Application Priority Data
Jan. 14, 2005 (JP) 2005-007789

(51) Int. Cl. B41J 3/36

(52) U.S. Cl. 347/109

(57) ABSTRACT

There is provided a tape printing apparatus in which a cartridge mounting unit where a tape cartridge having a print tape accommodated therein is detachably mounted, a battery accommodating unit where a plurality of batteries serving as power supply are accommodated, and a finger-hooking groove unit for removing the batteries from the battery accommodating unit are formed with a groove on a surface of an apparatus casing, wherein the finger-hooking groove unit and the cartridge mounting unit are disposed such that they are overlapped with each other in the plane of the surface.

The entire disclosure of Japanese Patent Application No. 2005-007789, filed Jan. 14, 2005, is expressly incorporated by reference herein.

### BACKGROUND

1. Technical Field

The present invention relates to a portable tape printing apparatus which performs a printing operation using batteries as power supply.

2. Related Art

A tape printing apparatus used hitherto is of a type which the user can operate in a hand-held state. JP-A-2004-195895 is an example of related art. In this tape printing apparatus, a cartridge mounting unit where a cartridge including a print tape is mounted and a battery accommodating unit where batteries are accommodated are formed on the back surface of an apparatus casing such that they are arranged in the longitudinal direction thereof. Furthermore, at the lateral part of the battery accommodating unit, a finger-hooking groove unit communicating therewith is formed. The battery accommodating unit has a total of four batteries arranged in two rows, which the user can easily remove by putting a finger in the finger-hooking groove unit.

However, effective space utilization is not possible with the tape printing apparatus of this type since the finger-hooking groove unit is formed independently with a groove, which prevents miniaturization of and reduces the number of accommodated batteries.

### SUMMARY

It is an advantage of the invention to provide a tape printing apparatus having a cartridge mounting unit, a battery accommodating unit, and a finger-hooking groove unit arranged therein with effective space utilization.

According to an aspect of the invention, there is provided a tape printing apparatus in which a cartridge mounting unit where a tape cartridge having a print tape accommodated therein is detachably mounted, a battery accommodating unit where a plurality of batteries serving as power supply are accommodated, and a finger-hooking groove unit for removing the batteries from the battery accommodating unit are formed with a groove on a surface of an apparatus casing. In the tape printing apparatus, the finger-hooking groove unit and the cartridge mounting unit are disposed such that they are overlapped with each other in the plane of the surface.

According to this configuration, a space for the finger-hooking groove unit other than the cartridge mounting unit and the battery accommodating unit can be made small since the finger-hooking groove unit is disposed so as to overlap with the cartridge mounting unit. Accordingly, the overlapped disposition makes it possible to set the battery accommodating unit that much nearer to the cartridge mounting unit, which in turn makes it possible to prevent the apparatus from growing in size even if the battery accommodating unit requires more space.

In this case, it is preferable that an auxiliary line representing the contour of the tape cartridge be provided at the groove bottom of the finger-hooking groove unit.

According to this configuration, the user is prevented from inserting the tape cartridge in the opposite direction since the auxiliary line indicates the contour of the tape cartridge.

In this case, it is preferable that the battery accommodating unit have a plurality of individual accommodating sections where the plurality of batteries are accommodated in a two-tiered system and arranged side by side, and the neighboring individual accommodating sections be disposed such that they are mutually shifted in the longitudinal direction of the batteries.

According to this configuration, it is possible that the plurality of batteries are intensively arranged and stepped portions generated according to the shifted disposition of the individual accommodating sections are used as positioning walls. Accordingly, the batteries can be easily installed without falling apart inside the battery accommodating unit in or during installation.

### BRIEF DESCRIPTION OF THE DRAWINGS

The invention will be described with reference to the accompanying drawings, wherein like numbers reference like elements.

FIG. 1 is an external perspective view of a tape printing apparatus as seen from the top side thereof.

FIG. 2 is an external perspective view of the tape printing apparatus as seen from the bottom side thereof.

FIG. 3 is an external perspective view of the tape printing apparatus as seen from the bottom side thereof.

FIG. 4 is a cross-sectional view showing the inner structure of a tape cartridge.

FIG. 5 is an external perspective view of the tape printing apparatus as seen from the bottom side thereof.

### DESCRIPTION OF EXEMPLARY EMBODIMENTS

Hereinafter, description will be made about a tape printing apparatus of the invention referring to the accompanying drawings. This tape printing apparatus is of a portable type mainly using batteries as power supply and performs a printing operation on a print tape which is fed out from a tape cartridge mounted on the back surface side, so as to form a strip label.

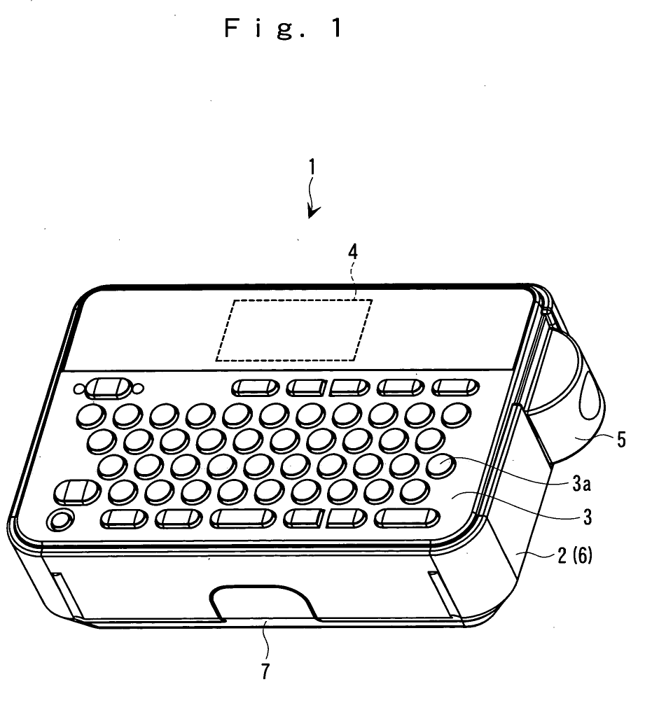

FIG. 1 is an external perspective view of the tape printing apparatus 1. As shown in FIG. 1, the tape printing apparatus 1 has a substantially rectangular box-shaped outer hull formed by an apparatus casing 2. On the front side of the apparatus casing 2, a keyboard 3 including various input keys 3a and complying with the JIS (Japanese Industrial Standards) and a display 4 are disposed on the near and far sides, respectively. On the right side surface of the apparatus casing 2, a semi-circular cutter operating lever 5 is disposed so that the print tape T is manually cut.

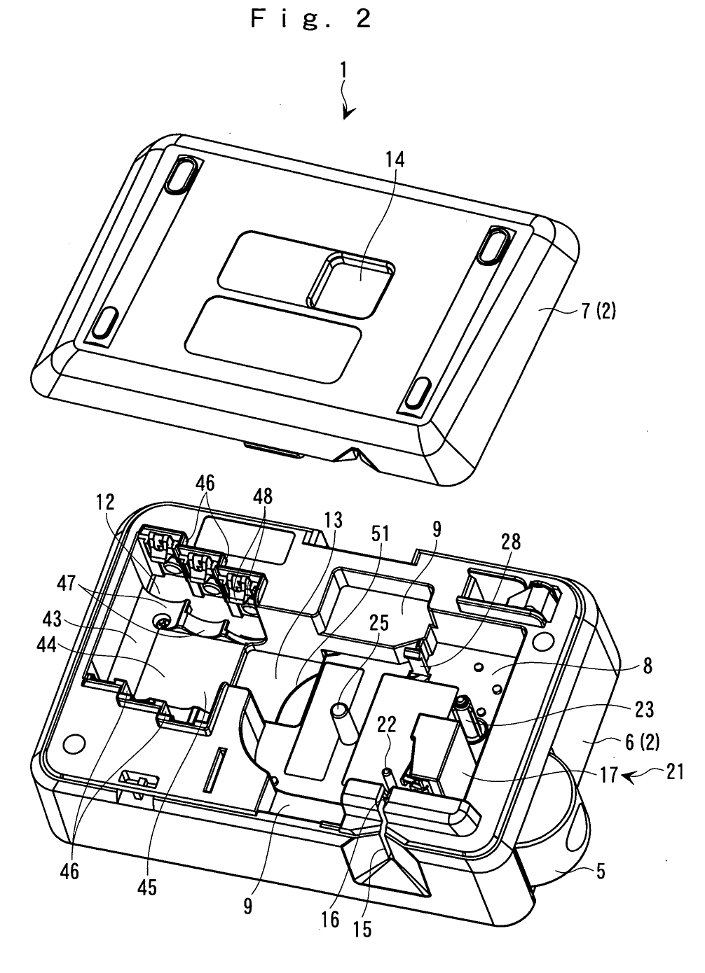

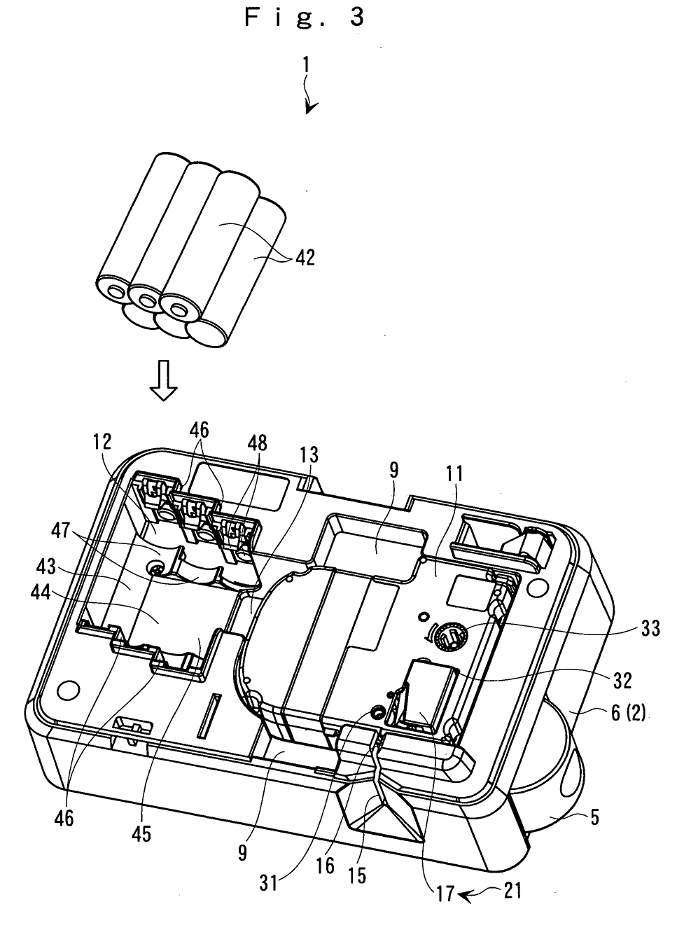

FIGS. 2 and 3 are external perspective views of the tape printing apparatus 1 as seen from the bottom side thereof. As shown in FIGS. 2 and 3, the apparatus casing 2 has a main body casing 6 accommodating a main portion of the apparatus and a lid casing 7 for closing the main body casing 6 from the back surface side. The lid casing 7 is detachably attached to the main body casing 6. On the back surface of the main body casing 6 with its lid casing 7 removed, a cartridge mounting unit 8 where the tape cartridge 11 is mounted, a battery accommodating unit 12 accommodating dry batteries 42, and a finger-hooking groove unit 13 for removing the dry batteries 42 are each formed with a groove. On the other hand, the lid casing 7 entirely covers the back surface of the main body casing 6 and has a view window 14 at the center thereof for visually identifying the mounting/non-mounting state of the tape cartridge 11 while the lid casing is closed.

On the right-rear end surface of the apparatus casing 2 as shown in FIGS. 2 and 3, a tape ejecting port 15 for communicating the cartridge mounting unit 8 and the outside thereof is formed, and a cutter 16 for cutting off the print tape T from inside the casing faces on the tape ejecting port 15. Although not specifically shown in the figures, the cutter 16 has a hand-push cutting blade manually operated by the use of the cutter operating lever 5 described above. When the cutter operating lever 5 is pushed, the cutting blade performs a cutting operation (cutting off) on the print tape T.

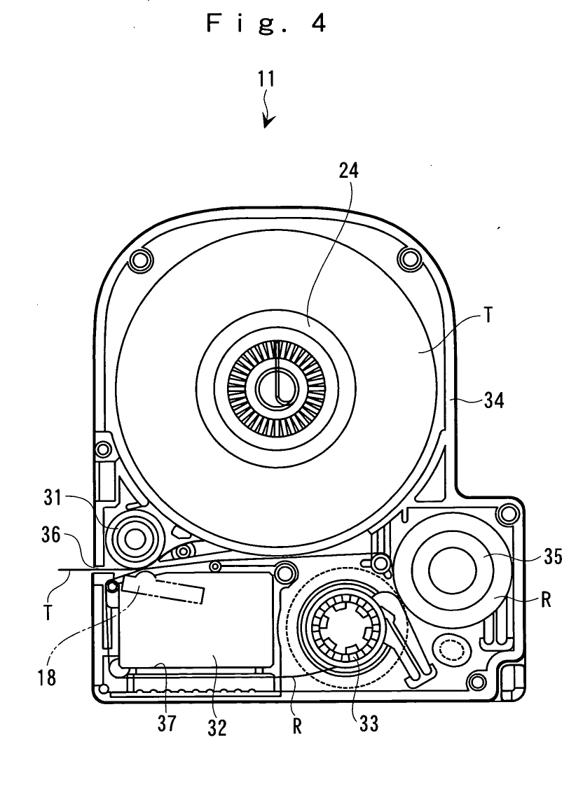

As shown in FIG. 2, the cartridge mounting unit 8 has a flat shape substantially mutually complementing that of the tape cartridge 11 and has a pair of grooves 9 formed therein for vertically removing the tape cartridge 11. With its left end removed, the cartridge mounting unit 8 communicates with the finger-hooking groove unit 13. The cartridge mounting unit 8 is projectingly provided with a head unit 21 having a head cover 17 where a print head 18 (see FIG. 4) serving as a thermal head is accommodated, a platen driving shaft 22 positioned opposite to the print head 18, a take-up driving shaft 23 for taking up the below-described ink ribbon R (see FIG. 4), a positioning boss 25 for a tape reel (see FIG. 4), and a pair of hooks 28 for fixing the mounted tape cartridge 11. In the space underneath the cartridge mounting unit 8, a print feed motor (not shown) for rotating the platen driving shaft 22 and the take-up driving shaft 23 and a power transmitting mechanism (not shown) are incorporated.

While the tape cartridge 11 is mounted on the cartridge mounting unit 8, the head unit 21, the positioning boss 25, the take-up driving shaft 23, and the platen driving shaft 22 are inserted into a through hole 32 of the tape cartridge 11, the tape reel 24, a ribbon taking-up reel 33, and a platen roller 31 (platen), respectively. When the lid casing 7 is closed in this state, the print head 18 is pressed by a head release mechanism (not shown) against the platen roller 31 as it sandwiches the print tape T and the ink ribbon R. The print head 18 in a printing standby state drives to perform a printing operation on the print tape T fed out by the platen roller 31. The post-printed print tape T is cut off (fully-cut) by the cutter 16 and ejected outside from the tape ejecting port 15.

FIG. 4 is a cross-sectional view showing the inner structure of the tape cartridge 11. As shown in FIG. 4, the tape cartridge 11 has a cartridge casing 34 constituting the contour thereof in which are accommodated the tape reel 24 around which the print tape T winds, a ribbon feeding reel 35 around which the ink ribbon R winds, a ribbon taking-up reel 33, and the platen roller 31 (platen). The ribbon feeding reel and the ribbon taking-up reel are accommodated in the lower right part of the cartridge casing, whereas the platen roller is accommodated in the lower left part thereof. Note that the print tape T wound about the tape reel 24 is held in the cartridge casing 34 with its tip end slightly projected from a tape feeding slit 36.

On the lower left side of the tape reel 24 is formed the through hole 32 into which the head unit 21 is inserted, and is disposed the platen roller 31 to be engaged with the platen driving shaft 22 of the apparatus corresponding to a position where the print tape T and the ink ribbon are overlapped with each other. The ink ribbon R fed out from the ribbon feeding reel 35 is transferred in such a way as to travel around opening walls 37 constituting the through hole 32 and is taken up by the ribbon taking-up reel 33. The print tape T fed out from the tape reel 24 overlaps with the ink ribbon R fed out from the ribbon feeding reel 35 at the position of the platen roller 31 and is subjected to thermal transfer printing by the use of the print head 18. The post-printed print tape T is fed out from the tape feeding slit 36, and the ink ribbon R is taken up by the ribbon taking-up reel 33.

The print tape T is composed of a recording tape (not shown) having an adhesive agent layer (not shown) on the back surface thereof and a peeling tape (not shown) affixed to the back surface of the recording tape with the adhesive agent layer. Note that the print tape T is available in widths of 6 mm, 9 mm, 12 mm, and 24 mm and in a plurality of types including colors. Although omitted in the figure, the ink ribbon R includes a substrate ribbon having ink coated on the front side thereof and is formed approximately in the same width as that of the print tape T. Note that a plurality of varied ink colors are available for the ink ribbon R.

Referring to FIGS. 2 and 3, description will now be made about the battery accommodating unit 12 and the finger-hooking groove unit 13 as well as about the positional relationship among the cartridge mounting unit 8, the battery accommodating unit 12, and the finger-hooking groove unit 13. As shown in FIGS. 2 and 3, the battery accommodating unit 12 is formed with a groove such that both sides of the batteries 42 in its longitudinal direction are formed in a staircase pattern. In other words, the battery accommodating unit 12 has a first accommodating section (individual accommodating section) 43 as shown on the upper left side of the figure, an intermediate second accommodating section (individual accommodating section) 44, and a third accommodating section (individual accommodating section) 45 as shown on the lower right side of the figure, and these respective accommodating sections 43, 44, and 45 are disposed such that they are mutually shifted (arranged in a stepped manner) in the longitudinal direction of the batteries 42. Furthermore, AA dry batteries 42 are accommodated in the respective accommodating sections 43, 44, and 45 in a two-tiered system (in pairs), which enables the battery accommodating unit 12 to accommodate a total of six AA dry batteries. Therefore, at a place between the first and second accommodating sections and that between the second and third accommodating sections, stepped portions 46 are formed from short sides (corners) to long sides of the respective accommodating sections 43, 44, and 45, which enables the respective dry batteries 42 to be positioned at the respective accommodating sections 43, 44, and 45.

Furthermore, at the bottom of the battery accommodating unit 12, receiving portions 47 having a recessed shape and complementing the peripheral surface of the cylindrical dry batteries 42 are formed to permit defining the position of the dry batteries 42 in the lower tier. Note that, in the battery accommodating unit 12, terminal fittings 48 in contact with both electrodes of the respective dry batteries 42 are projectingly provided, and the dry batteries 42 in pairs are connected in series (9-volt power supply).

As shown in FIGS. 2 and 3, the finger-hooking groove unit 13 has a substantially rectangular shape as seen from the top side thereof and is formed with a groove at a level deeper than any of the cartridge mounting unit 8 and the battery accommodating unit 12. In this case, the finger-hooking groove unit 13 is large enough in size to permit the user to put a finger therein while the tape cartridge 11 is removed. Furthermore, the finger-hooking groove unit 13 is disposed on the back surface of the main body casing such that it partially overlaps with the cartridge mounting unit 8. Accordingly, a part of the finger-hooking groove unit 13 serves as the cartridge mounting unit 8 for effective space utilization. Furthermore, the bottom of the third accommodating section 45 is designed to partially overlap with the finger-hooking groove unit 13 (see FIG. 2), and the user can easily detach the dry batteries 42 by putting a finger in the finger-hooking groove unit 13. It is also possible for the user to remove the tape cartridge 11 by using the finger-hooking groove unit 13 when it is mounted on the cartridge mounting unit 8.

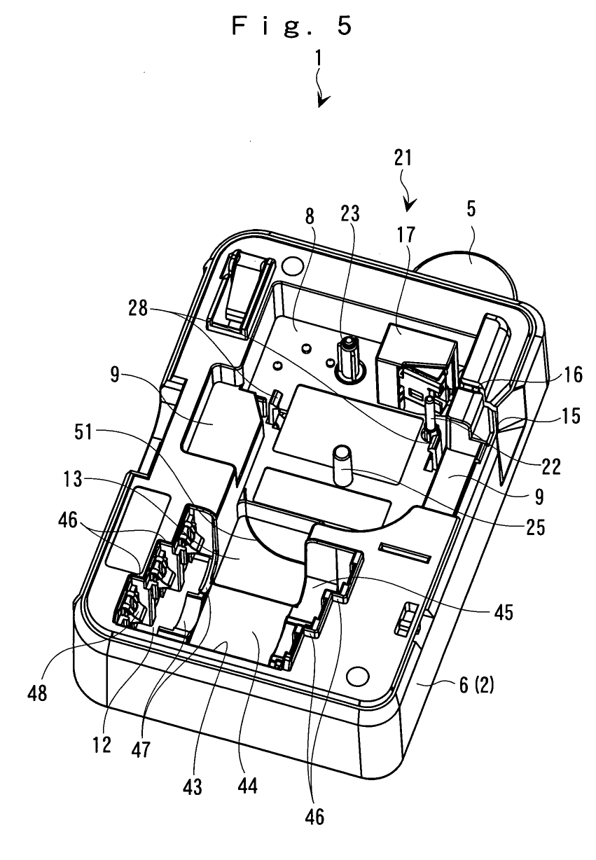

Furthermore, as shown in FIG. 5, an auxiliary line 51 representing the contour of the tape cartridge 11 is provided at the groove bottom of the finger-hooking groove unit 13, which enables the user to easily recognize the contour of the tape cartridge 11. Accordingly, the user is prevented from hesitating to define the inserting direction of the tape cartridge 11. An auxiliary line 51 may be convex, groove and coloring, etc.

According to the present embodiment described above, the finger-hooking groove unit 13 for removing batteries is provided so as to overlap with the cartridge mounting unit 8, thereby attaining miniaturization of the apparatus without sacrificing the number of the accommodated dry batteries 42.

It is further understood by those skilled in the art that the foregoing is the preferred embodiment of the present invention, and that various changes and modifications may be made without departing from the spirit and scope thereof.

What is claimed is:

1. A tape printing apparatus in which a cartridge mounting unit where a tape cartridge having a print tape accommodated therein is detachably mounted, a battery accommodating unit where a plurality of batteries serving as power supply are accommodated, and a finger-hooking groove unit for removing the batteries from the battery accommodating unit are formed with a groove on a surface of an apparatus casing, wherein
the finger-hooking groove unit and the cartridge mounting unit are disposed such that they are overlapped with each other in the plane of the surface.

2. The tape printing apparatus according to claim 1, wherein
an auxiliary line representing the contour of the tape cartridge is provided at the groove bottom of the finger-hooking groove unit.

3. The tape printing apparatus according to claim 1, wherein
the battery accommodating unit has a plurality of individual accommodating sections where the plurality of batteries are accommodated in a two-tiered system and arranged side by side, and the neighboring individual accommodating sections are disposed such that they are mutually shifted in the longitudinal direction of the batteries.
